(19) United States
(12) Patent Application Publication
(10) Pub. No.: US 2025/0343805 A1
(43) Pub. Date: Nov. 6, 2025

(54) METHOD FOR FACILITATING DETECTION OF THREATS IN A NETWORK AND SYSTEM THEREFOR

(71) Applicant: FireDome Ltd., Herzliya (IL)

(72) Inventors: Orr CHEN, Tel Aviv (IL); Moti SHKOLNIK, Rishpon (IL); Guy GOLDFARB, Hod Hasharon (IL); Netta Dafna SCHMEIDLER, Herzliya (IL); Aviv SINAI, Kadima-Zoran (IL)

(21) Appl. No.: 18/655,438

(22) Filed: May 6, 2024

(51) Int. Cl. H04L 9/40

(52) U.S. Cl. CPC H04L 63/1416

(57) ABSTRACT

A computer-implemented method for facilitating detection of threats in a network is provided. The method includes a) selecting at least one group of network entities, based on a respective calculated risk score of the one or more network entities; and b) for network entities within the selected group, determining at least one respective type of traffic data collection method appropriate for traffic exchanged with these network entities, thereby facilitating the application of one or more security techniques to detect threats using data collected according to the respective type.

### TECHNICAL FIELD

The presently disclosed subject matter relates to cyber security, particularly to facilitating the detection of threats in communications exchanged between network entities in a network.

### BACKGROUND

The landscape of network communication has rapidly evolved, becoming indispensable in the digital era and underscoring the need for stringent security mechanisms. Traditional security measures are increasingly challenged by sophisticated cyber threats, revealing significant gaps in detection and response capabilities.

In the realm of Network Detection and Response (NDR), the focus is on enhancing the visibility of organizational networks to effectively detect and respond to potential threats. Presently, the examination and management of network traffic predominantly rely on hardware-based solutions. Such solutions involve integrating hardware devices with essential network components like routers and switches, enabling the monitoring of traffic. While employing Deep Packet Inspection (DPI), these devices meticulously analyze all data passing through the network to identify potential security threats. However, these hardware-based approaches demand significant resources and necessitate a tangible integration within the network's infrastructure. These approaches typically require the deployment of devices capable of capturing traffic copies, conducting packet sniffing, and duplicating traffic across network ports. These devices are expected to have substantial processing power to analyze data either locally or by offloading it to cloud services.

Meanwhile, alternative software-based solutions offer a different approach, primarily through traffic sampling or focusing on metadata analysis. These methods, which involve monitoring select segments of network traffic or examining data characteristics such as the metadata of the traffic without analyzing the content, are considered to be inferior and less effective compared to the DPI strategies. Hence, while these solutions provide some level of security, they are often hampered by their inherent limitations in scalability, flexibility, and resource efficiency.

Given the finite resources inherent to network environments, there is a pressing need for a security strategy that effectively counters the diverse array of threats facing organizational networks, while optimizing resource utilization. This approach must not only address a broad spectrum of emerging threats with high efficiency, but also provide a scalable and flexible infrastructure. Moreover, it is crucial that this solution maintains a balance between efficiency and comprehensive security, adapting seamlessly to the dynamic nature of the system and evolving network conditions.

### GENERAL DESCRIPTION

In addressing the challenge of optimizing network resources while ensuring robust security measures against an ever-evolving landscape of cyber threats, it may be advantageous to determine a monitoring strategy for an organization network, which considers the variety of network entities operating with the network. It may also be advantageous to revisit the strategy, periodically, to adhere to the dynamic nature of operation in a network.

According to certain embodiments of the presently disclosed subject matter, there is a provided a method for facilitating detection of threats in a network. The disclosed subject matter aims to consider the approach to network security by dynamically selecting network entities for different types of monitoring methods, based on real-time risk assessments and other network and organization considerations. Entities within the network can be grouped based on risk assessment of the entities, and different types of monitoring methods can be determined to be applied for each group. The determination which method to apply can be periodically repeated, thus adhering to the dynamic nature of network activity.

Determining various monitoring methods for different groups of entities within the network and dynamically revising the determination facilitates that the organization security resources are allocated more efficiently, focusing on high-risk areas within the network, without the need for constant monitoring of all traffic of all devices.

Moreover, by employing a dynamic classification process of the network entities to groups of entities having different monitoring methods, or, alternatively, by a selection process, in which devices within the network are selected for a certain type of monitoring method, the system can adjust its monitoring focus in response to changes in network behavior or threat intelligence, thereby enhancing the ability to pre-emptively identify and mitigate potential threats before they escalate. This approach not only improves the effectiveness of the security measures, but also significantly reduces the resource burden typically associated with comprehensive monitoring strategies. The advantage of the claimed subject matter also lies in its ability to maintain a robust security posture while optimizing the use of network resources. The system is designed to evaluate the risk associated with different network entities continuously and adjust its monitoring parameters accordingly. This capability allows for targeted security interventions that are both effective and efficient.

According to a first aspect of the presently disclosed subject matter there is provided a computer-implemented method for facilitating detection of threats in a network, comprising:
a) selecting at least one group of network entities, based on a respective calculated risk score of the one or more network entities; and
b) for network entities within the selected group, determining at least one respective type of traffic data collection method appropriate for traffic exchanged with these network entities, thereby facilitating an application of one or more security techniques to detect threats using data collected according to the respective type.

In addition to the above features, the computer implemented method according to this aspect of the presently disclosed subject matter can optionally comprise in some examples one or more of features (i) to (xi) below, in any technically possible combination or permutation:
(i). Wherein selecting at least one group comprises classifying the network entities into multiple groups based on their respective calculated risk scores.
(ii). Wherein determining the at least one type is according to determination criteria.
(iii). Wherein the determination criteria comprise at least one criterion selected from a group comprising: the risk score, characteristics of the network entity, constraints of an organization operating the network, network resources, and a combination thereof.
(iv). The method further comprising repeating steps (a) and (b), and redetermining the appropriate traffic data collection method.
(v). Wherein redetermining of the appropriate traffic data collection method includes selecting a different type of traffic data collection method for the network entities based on a change in at least one criterion comprised in the determination criteria.
(vi). Wherein repeating the steps is executed in real-time.
(vii). Wherein repeating the steps is executed in response to receipt of a threat indication.
(viii). The method further comprising: applying at least one security method based on the determined type.
(ix). Wherein the type of traffic data collection method includes at least one security technique selected from a group comprising: Deep Packet Inspection (DPI), signature engines, machine learning methods, behavioral analysis techniques, anomaly detection, intrusion detection systems (IDS), heuristic evaluation methods, or a combination thereof.
(x). The method further comprising: determining at least two different types of traffic data collection methods, each respectively determined to fall into two different groups among the one or more groups, wherein each method is selected based on at least one distinct characteristic specific to each group.
(xi). Wherein each method is further determined based on determination criteria, comprising at least one criterion selected from a group comprising: the risk scores, types of the network entities, constraints of an organization operating the network, network resources, and a combination of the above.

The presently disclosed subject matter further comprises a computer system for facilitating detection of threats in a network comprising a processing circuitry that comprises at least one processor and a computer memory, the processing circuitry is configured to execute a method as described above with reference to the first aspect and may optionally further comprise one or more of the features (i) to (xi) listed above, mutatis mutandis, in any technically possible combination or permutation.

The presently disclosed subject matter further comprises a non-transitory computer readable storage medium tangibly embodying a program of instructions that, when executed by a computer, cause the computer to perform a method as described above with reference the first aspect, and may optionally further comprise one or more of the features (i) to (xi) listed above, mutatis mutandis, in any technically possible combination or permutation.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a generalized network environment 100 operating a method for facilitating detection of threats in a network, in accordance with certain embodiments of the presently disclosed subject matter;

FIG. 2 illustrates a functional block diagram of monitoring system 200, in accordance with certain embodiments of the presently disclosed subject matter; and

FIG. 3 illustrates a generalized flowchart of operations performed by the monitoring system 200, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that throughout the specification discussions utilizing terms such as “classifying”, “determining”, “applying”, “repeating”, “obtaining”, “calculating”, “identify”, or the like, refer to the action(s) and/or process(es) of a computer that manipulate and/or transform data into other data, said data represented as physical, such as electronic, quantities and/or said data representing the physical objects.

The term “computer”, “computer system”, “computer device”, “computerized device”, “computerized method” or the like, should be expansively construed to cover any kind of hardware-based electronic device with one or more data processing circuitries. A processing circuitry can comprise, for example, one or more processors operatively connected to computer memory of any suitable sort, loaded with executable instructions for executing operations, as further described below. The one or more processors referred to herein can represent, for example, one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a graphics processing unit (GPU), a network processor, or the like. By way of non-limiting example, computerized systems or devices can include monitoring system 200, disclosed in the present application.

The operations in accordance with the teachings herein may be performed by a computer specially constructed for the desired purposes, or by a general-purpose computer specially configured for the desired purpose by a computer program stored in a non-transitory computer-readable storage medium.

As used herein, phrases including “for example”, “such as”, “for instance” and variants thereof, describe non-limiting embodiments of the presently disclosed subject matter. Usage of conditional language, such as “may”, “might”, or variants thereof, should be construed as conveying that one or more examples of the subject matter may include, while one or more other examples of the subject matter may not necessarily include, certain methods, procedures, components, and features. Thus, such conditional language is not generally intended to imply that a particular described method, procedure, component, or circuit is necessarily included in all examples of the subject matter. Moreover, the usage of non-conditional language does not necessarily imply that a particular described method, procedure, component, or circuit is necessarily included in all examples of the subject matter. Also, reference in the specification to “one case”, “some cases”, “other cases”, or variants thereof, means that a particular feature, structure, or characteristic described in connection with the embodiment(s) is included in at least one embodiment of the presently disclosed subject matter. Thus, the appearance of the phrase “one case”, “some cases”, “other cases”, or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

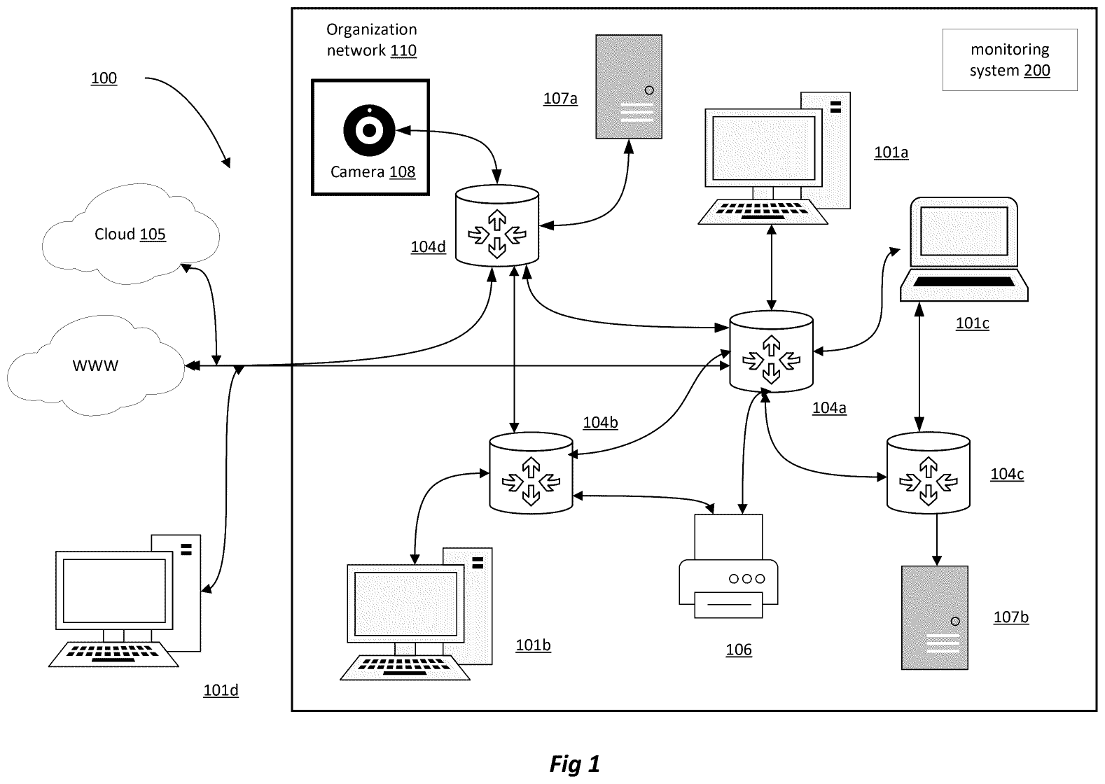

Bearing this in mind, attention is drawn to FIG. 1 illustrating a generalized network environment 100 and an organization network 110 operating a monitoring system 200 for facilitating detection of threats in the organization network, in accordance with certain embodiments of the presently disclosed subject matter. Although the monitoring system 200 is illustrated as comprised in the network 110, those versed in the art would realize that it can be located outside the network 110 and can communicate with the network 110 to provide input to the network 110. The environment 100 is configured to facilitate the execution of a computer-implemented method for facilitating detection of threats in a network. The detecting of threats can be in communications exchanged between network entities in organization network 110. A communication can be regarded as any network traffic including, e.g., data packets transmitted in the network.

The environment 100 may include several entities, all operatively communicating with each other via a network. The environment 100 may include the organization network 110 (referred to also as ‘network 110’), and other entities which reside outside the network 110. The network 110 may include a plurality of network entities, operatively connected to each other, and communicate through a network infrastructure that is owned or operated by an organization or a group of linked organizations. The network entities within the network 110 may comprise computers 101a-101c such as desktop computers 101a, 101b, or laptops such as 101c. The network entities comprised in network 110 may also comprise one or more printers 106, one or more servers 107a-170b, one or more one or more cameras 108, storage entities, containers, virtual machines (not shown), IoT devices, cameras, IP phones, and any other network entity configured for communicating in the network 110. The network 110 can also include one or more routers 104, such as 104a and 104b. The environment 100 may comprise also network entities residing outside the network 110 configured for communicating with network entities within the network 110, such as the computer 101d and services in the cloud 105.

In some cases, the entities in network 110 and outside it are configured to communicate with each other by initiating and receiving communications between themselves. The routers 104a-104b are configured to route the communications exchanged between the entities in network 110.

Assuming an organization operates network 110 that implements a method to facilitate the detection of threats in a network and operates a monitoring system, according to the presently disclosed subject matter. While the organization may initially desire to monitor all traffic exchanged with every network entity within the network 110, organization and network constraints, as well as resource availability, might limit monitoring traffic exchanged with only a subgroup of all operating entities. Therefore, the monitoring system operated by the organization may identify and select which network entities belong to this subgroup or classify the entire network into groups based on their risk levels. For the selected network entities or for each classified group, the monitoring system then determines the appropriate type of data collection method to be applied on exchanged traffic. For groups comprising high-risk network entities, more in-depth data collection methods might be required, which extract a comprehensive level of data from the communications. Conversely, for groups containing low-risk network entities, shallower data extraction methods, such as those focusing on surface-level metadata, may suffice. The chosen data collection method facilitates the application of one or more security techniques to detect threats using the data collected according to the determined method.

In order to facilitate detection of threats in a network, the monitoring system may implement a method involving classifying network entities based on their risk scores and determining appropriate traffic data collection methods for communications involving these entities. The classification and determination of appropriate data collection methods, enables the implementation of targeted security techniques to proactively identify and mitigate potential threats, thereby enhancing the security posture of the network.

It should be noted that in this disclosure, “monitoring”-whether referenced in terms of a ‘monitoring system’ or ‘monitoring communications’-denotes a comprehensive and dynamic approach that goes beyond traditional security techniques such as Deep Packet Inspection (DPI), commonly found in prior art systems. Instead, here, monitoring involves a proactive process of determining the most appropriate type of traffic data collection method for communications with specific network entities. This process may involve the assessment of the risk levels associated with network entities. Based on the risk assessment of each entity or group of entities, together with other considerations, a selection of a data collection method, from a range of data collection methods, is made. Based on the risk assessment, the selected data collection method may vary from in-depth approaches like DPI to shallower techniques such as metadata or header analysis. By customizing the data collection strategy to meet the specific security needs and risk profiles of each entity or group of entities, the monitoring system can optimize resource allocation across the organization, thereby enhancing its ability to effectively identify, analyze, and mitigate potential threats. This tailored approach ensures a higher level of security management that is both adaptive and precise.

Also, the description throughout this document refers, for illustration only, to network entities in an organization network 110 which resides on the organization's premises, however, this disclosure should not be limiting, and those versed in the art would realize that it includes also cloud environments, where the organization network 110 is implemented, partially or entirely, in the cloud.

As depicted in FIG. 1, the network entities are grouped into distinct groups, each represented by a different shade of grey and the camera in black rectangle. These groups might include, for example, high-risk entities such as camera 108, medium-risk entities such as old servers 107, standard operational computers in the next risk group such as computers 101, and peripheral entities having low risk profile like printers 106 and IoT entities in the group. Grouping of the entities can be done at least based on risk assessment of the entities. For each of these groups, a specific type of traffic data collection method is determined based on the unique security needs and risk profiles associated with the network entities within the group. The type of traffic data collection method may range from in-depth methods for the highest and second high risk groups including the camera 108 and old servers 107, to shallower data extraction methods for the lower-risk network entities including the computers 101 and the printer 106. As illustrated further below, depending on the assessed risk and other organization and network criteria, the same type of data collection method could be applied to two different groups having different risk levels. This tailored approach allows the system to efficiently allocate security resources while ensuring that each group receives an appropriate level of monitoring and detection.

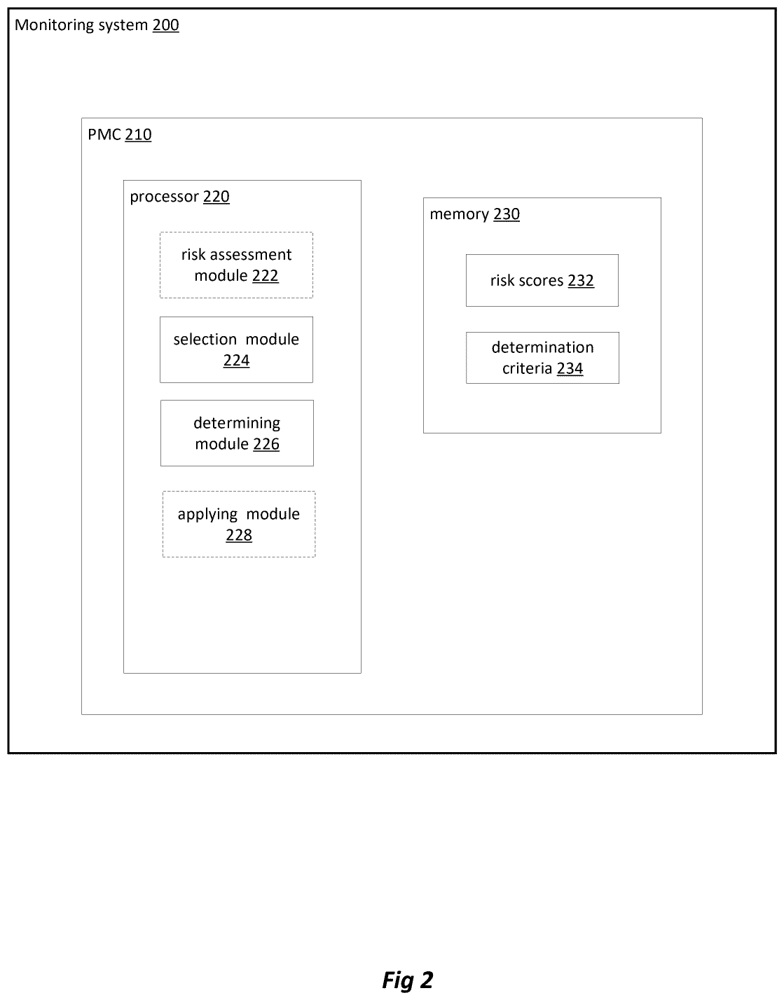

Attention is drawn to FIG. 2 illustrating a high-level functional block diagram of a monitoring system 200, in accordance with certain embodiments of the presently disclosed subject matter.

The system 200 comprises a processor and memory circuitry (PMC) 210 comprising a processor 220 and a memory 230. The processor 220 is configured to execute several functional modules in accordance with computer-readable instructions implemented on a non-transitory computer-readable storage medium such as memory 230. Such functional modules may be realized by software stored in memory and executed by the processor 220. The processor 220 can implement a risk assessment module 222, a selection module 224, a determining module 226 and an applying module 228.

The risk assessment module 222 is configured to obtain the risk scores of entities within the network. This may be achieved by calculating risk scores directly e.g. using known methods, or by obtaining them from external tools designed for assessing the risk scores of network entities. Additionally, risk assessment module 222 is configured to receive new indications of potential risk pertaining to one or more network entities, such as those received from a firewall system operating within the network 110, or an external threat intelligence system, from analyzing the recent network behavior of those entities.

The selection module 224 is configured to select at least one group of network entities based on the risk scores obtained from the risk assessment module 222. In addition, in some examples, the selection module 224 is configured to classify the network entities into multiple groups based on their respective calculated risk scores. The determining module 226 is configured to determine the appropriate type of traffic data collection method for each group of network entities. The determining module 226 can select the method that is most appropriate for the specific security requirements and risk profiles of each group. Finally, the applying module 228 is configured to apply specific security methods based on the traffic data collection methods determined by the determining module 226. The memory 230 may store calculated risk scores 232 including risk assessment scores of entities within the network, as obtained from the risk assessment module 222. The memory 230 may also store determination criteria 234 including one or more criteria comprising at least risk scores, types of network entities, constraints of an organization operating the network and network resources.

Elements in FIG. 2 can be made up of any combination of software and hardware and/or firmware that performs the functions as defined and explained herein. Elements in FIG. 2 may be centralized in one location or dispersed over more than one location. For example, each one of elements 222, 224, 226, and 228 can be located at a different geographical location, remote from the other elements. Furthermore, in some examples of the presently disclosed subject matter, the monitoring system 200 may comprise fewer, more, and/or different elements than those shown in FIG. 2. For example, elements 224 and 226 form as separate elements, each dedicated for executing certain functions of the system, however it will be clear to any person skilled in the art that the functionalities of the system can be otherwise divided. For instance, in an alternative system-design, different functions assigned to applying module 228 can be otherwise implemented by determining module 226. Likewise, various elements described as distributed over different computers can be otherwise consolidated into a single computer device.

Those skilled in the art will also readily appreciate that the memory 230 can be consolidated or divided differently; databases can be shared with other systems or can be provided by other systems, including third-party equipment. Specifically, memory 230 can be stored external to the system 200, and the system 200 can communicate with the memory 230, e.g. using a communication interface (not shown).

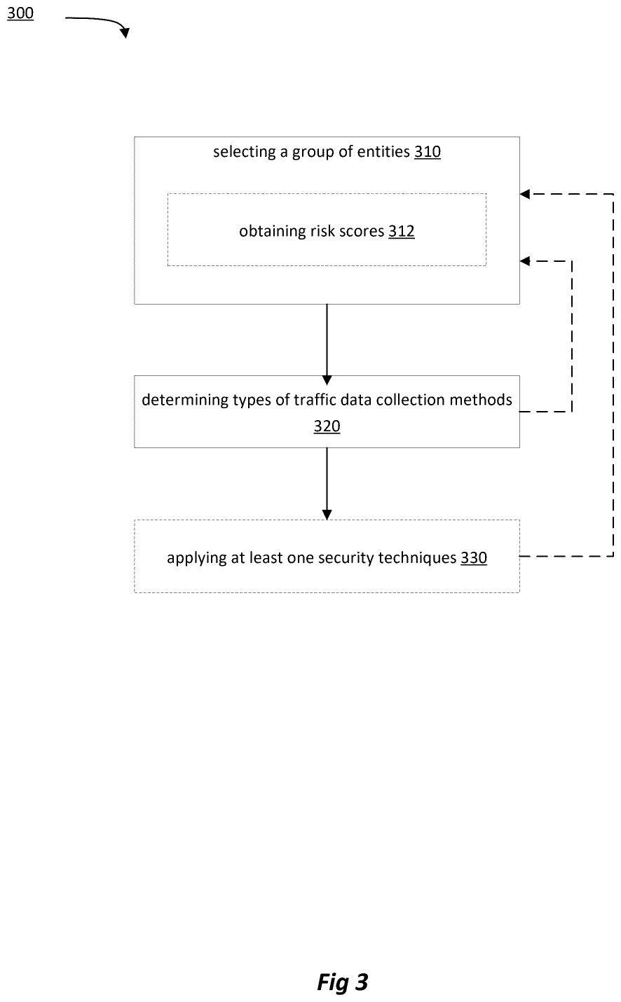

Referring to FIG. 3, there is illustrated a generalized flow chart 300 of operations performed by the monitoring system 200, in accordance with certain embodiments of the presently disclosed subject matter. The following flowchart operations are described with reference to elements of monitoring system 200. However, it is important to note that these operations can also be executed by alternative components not explicitly described herein.

As depicted in FIG. 3, in order to facilitate detection of threats in a network, a computer-implemented method is described. In some cases, the method initiates by selecting at least one group of network entities in the network 110, based on a respective calculated risk score (block 310). The selection can be performed by the selection module 224. In some examples, the selection module 224 can classify the network entities into multiple groups based on their respective calculated risk scores. For the purpose of this disclosure, the selecting of at least one group can comprise classifying the plurality of network entities. Classification can be done e.g. using known methods for classifying entities based on risk parameters.

In order to select the entities, risk scores of the entities may be obtained (block 312), e.g., by risk assessment module 222. The risk assessment module 222 can obtain the risk scores of the entities by calculating risk scores directly e.g. using known methods, or by obtaining them from external tools designed for assessing the risk scores of network entities. Additionally, risk assessment module 222 can receive new indications of potential risks pertaining to one or more network entities, such as those received from a firewall system operating within the network 110, and may calculate risk scores for the network entities considering also the indication, e.g. using known methods. In some examples, risk scores are calculated for all network entities, while in some other examples, risk scores are calculated only for a subgroup of the network entities. For example, manual or automatic exclusion of low-risk network entities or non-functional entities, from risk assessment, can be made. Accordingly, these low-risk network entities, or non-functional entities, can optionally be excluded from the selection or the classification process.

Calculating risk scores of network entities can be performed using known methods of risk assessment, such as active scanning of network entities and monitoring their responses, assessing the risk scores based on various parameters such as the types of the network entities, the history of traffic exchanged with the network entities, history of previous attacks, history of breaches of network entities, vulnerability scanning, configuration scanning, asset type classification, or a combination of the parameters.

After the risk scores are calculated, the selection module 224 can select one or more network entities based on the respective calculated risk score of the network entities. Alternatively, or additionally, the selection module 224 can then classify the network entities into one or more groups. The method of selection or classification may vary depending on several factors. In some instances, the organization may decide in advance to group the entities into a predetermined number of groups, based on historical data or organizational policy. In other scenarios, the distribution of risk scores among the network entities is analyzed, and groups are formed dynamically to ensure that entities with similar risk profiles are grouped together. This allows for a more tailored approach to applying security measures, where the nature of the threat and the vulnerability of the entities are more closely aligned. Furthermore, the method of grouping can also be influenced by the available resources, particularly the different methods of traffic data collection available. The organization may assess its capability to monitor and manage network traffic, and then decide on the grouping strategy that best utilizes these resources. For example, if intensive data collection methods like DPI are limited in capacity, higher-risk groups may be smaller to ensure that these resources are not overwhelmed, while lower-risk groups might be larger and subjected to less intensive monitoring techniques. Adopting a flexible approach of selection is advantageous as the organization can optimize its security infrastructure to ensure that resources are allocated efficiently and that the security measures are commensurate with the assessed risk levels of the network entities.

Following the selection of entities to groups, the process proceeds to determine at least one respective type of traffic data collection method appropriate for traffic exchanged with the network entities in the one or more groups, optionally, in each group (block 320). Determining the suitable type of traffic data collection method for at least one group can facilitate the application of one or more security techniques to detect threats, using data collected according to the respective type. The type of traffic data collection method employed may incorporate one or more advanced security techniques. These techniques can include Deep Packet Inspection (DPI), signature engines, machine learning methods, behavioral analysis techniques, anomaly detection, intrusion detection systems (IDS), and heuristic evaluation methods. Additionally, a combination of these techniques may also be used, depending on the specific security needs and the risk profile of the network entities being monitored.

In some examples, determining the suitable type of traffic data collection method can be according to determination criteria. The determination criteria can comprise a plurality of criteria such as the risk score, characteristics of the network entity including its type and the amount of traffic sent by the entity, constraints of an organization operating the network, network resources, and a combination of criteria. For example, one criterion can be the amount of traffic an entity is sending. For example, a very small amount is not of interest to track, whereas a too large amount (video streaming, for instance) may exhaust the network resources dedicated for monitoring.

Determining at least one type of traffic data collection method according to the determination criteria can comprise at least one of the criteria.

After determining the types of traffic data collection methods, the process can continue to apply at least one security method, based on the determined type, to detect threats using data collected according to the respective type (block 330). The purpose of applying security techniques is to detect potential threats in real-time in communication exchanged within entities in groups. Some examples of security methods include anomaly detection, behavioral analysis, and signature-based detection.

In some examples, the steps of selecting network entities (block 310) and determining the type of traffic data collection method (block 320) can be repeated, e.g., periodically, to redetermine the most suitable traffic data collection method. This repetition may involve re-obtaining risk scores (block 312), where updated risk scores are acquired by the risk assessment module 222 through newly performed calculations for the network entities. Based on these updated risk scores, new groups of entities can be selected and/or classified, and a different traffic data collection method can be redetermined for the new groups, as described above according to the determination criteria. The advantage of reassessing the methods based on updated risk scores lies in the ability to review and adjust the previous monitoring strategy implemented by monitoring system 200. This adjustment is advantageous as it accommodates dynamic changes in the risk landscape of network 110, ensuring that the monitoring strategy remains effective and relevant, despite changes occurring in the risk scores of entities. As a result of selecting new entities, optionally, classifying into new groups and redetermining the types of traffic data collection methods, different security techniques can be applied for the entities.

Repeating the steps of selecting network entities (block 310) and determining (block 320) and repeating the steps of selecting (block 310), determining (block 320) and applying security techniques (block 330) may occur at regular intervals, such as hourly, daily, or weekly, or may be triggered on-demand in real time, to reassess and redetermine the appropriate traffic data collection method. For instance, the initiation of this process might occur in response to the receipt of an unexpected threat indication by the risk assessment module 222, triggering a reassessment and redetermination of the suitable traffic data collection method. The repetition of these steps can be limited to a specific subgroup of entities, maintaining the existing grouping for those entities for which reassessment is not deemed necessary.

In some examples, redetermining of the appropriate type of traffic data collection method includes selecting a different type of traffic data collection method for network entities, based on a change in one or more criteria comprised in the determination criteria. For example, in case the available network resources are reduced, or since the risk score of an entity is increased, then a different type of traffic data collection method should be applied on the entities of the group of entities. Redetermining of the appropriate type can be for a particular network entity, e.g. since it was now classified to a different group, or to the entire group, e.g. since the availability of the network resources has been changed.

Assume, for instance, that printer 106 was initially classified into a group with a low-risk profile. Accordingly, a shallow data extraction method that involves analyzing only the metadata or headers of communications was determined to be sufficient for exchanges involving this printer. However, if a breach indication is received concerning printer 106, the situation changes significantly, and the monitoring strategy should be promptly adjusted. Upon receiving this threat indication, the risk assessment module 222 triggers a re-evaluation of the monitoring strategy. This indication triggers the repetition of both the classification and determination steps previously outlined. Consequently, the classification of printer 106 may be revised, moving it from a low-risk to a higher-risk group based on the new threat information. Accordingly, the type of traffic data collection method is also reevaluated and adjusted from a shallow method to a more comprehensive one, such as DPI. This change ensures that the monitoring strategy is dynamically aligned with the current risk conditions, and that the security measures are sufficiently robust to address and mitigate the newly identified threat on printer 106 and the network 110, effectively, in real time.

In cases where the network entities have been classified into a plurality of groups, based on their respective calculated risk scores, different types of traffic data collection methods can be determined to fall into two distinct groups. Each data collection method may be selected based on distinct characteristics that are specific to each group, ensuring that the approach is optimally aligned with the unique security requirements and risk profiles of these groups.

Further refining the process, the determination of each traffic data collection method may be guided by the determination criteria as described above, including, e.g., the risk scores of the entities, the types of the network entities, constraints imposed by the organization operating the network, the available network resources, or a combination thereof.

It is noted that the teachings of the presently disclosed subject matter are not bound by the flow chart illustrated in FIG. 3, and that the illustrated operations can occur out of the illustrated order. For example, in the illustration of repeating operations <310> to <330>, the operations <310> and <330> shown in succession can be executed substantially concurrently or in the reverse order, depending on the round of execution of the operations.

In various examples of the presently disclosed subject matter, fewer, more, and/or different stages than those shown in FIG. 3 may be executed.

It should be noted that the term “criterion” as used herein should be expansively construed to include any compound criterion, including, for example, several criteria and/or their logical combinations. Also, the specific examples of criteria should not be considered as limiting, and those skilled in the art will readily appreciate that the teachings of the presently disclosed subject matter are, likewise, applicable to other criteria.

Those versed in the art will realize that additional or other criteria can be determined, e.g., based on the operation of the particular organization network and the specific resources it utilizes.

Also, it is noted that, as is well known in the art, systems operating in real time may experience some delay between the onset of a command and its execution, due to various reasons such as processing time and/or network communication delay. The term real-time as used herein is meant to include near real-time i.e., operation in systems that may experience some internal delays.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the concept upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined by the appended claims.

1. A computer-implemented method for facilitating detection of threats in a network, comprising:
a) selecting at least one group of network entities, based on a respective calculated risk score of the one or more network entities; and
b) for network entities within the selected group, determining at least one respective type of traffic data collection method appropriate for traffic exchanged with these network entities, thereby facilitating an application of one or more security techniques to detect threats using data collected according to the respective type.

2. The method of claim 1, wherein selecting at least one group comprises classifying the network entities into multiple groups based on their respective calculated risk scores.

3. The method of claim 1, wherein determining the at least one type is according to determination criteria.

4. The method of claim 3, wherein the determination criteria comprise at least one criterion selected from a group comprising: the risk score, characteristics of the network entity, constraints of an organization operating the network, network resources, and a combination thereof.

5. The method of claim 1, further comprising repeating steps (a) and (b), and redetermining the appropriate traffic data collection method.

6. The method of claim 3, wherein redetermining of the appropriate traffic data collection method includes selecting a different type of traffic data collection method for the network entities based on a change in at least one criterion comprised in the determination criteria.

7. The method of claim 5, wherein repeating the steps is executed in real-time.

8. The method of claim 5, wherein repeating the steps is executed in response to receipt of a threat indication.

9. The method of claim 1, further comprising:
applying at least one security method based on the determined type.

10. The method of claim 1, wherein the type of traffic data collection method includes at least one security technique selected from a group comprising:
Deep Packet Inspection (DPI), signature engines, machine learning methods, behavioral analysis techniques, anomaly detection, intrusion detection systems (IDS), heuristic evaluation methods, or a combination thereof.

11. The method of claim 2, further comprising:
determining at least two different types of traffic data collection methods, each respectively determined to fall into two different groups among the one or more groups, wherein each method is selected based on at least one distinct characteristic specific to each group.

12. The method of claim 11, wherein each method is further determined based on determination criteria comprising at least one criterion selected from a group comprising: the risk scores, types of the network entities, constraints of an organization operating the network, network resources, and a combination of the above.

13. A computer system for facilitating detection of threats in a network, the system comprising a processing circuitry comprising at least one processer and computer memory, the processing circuitry being configured to execute a method as defined by claim 1.

14. A non-transitory computer readable storage medium tangibly embodying a program of instructions that, when executed by a computer, cause the computer to perform a method for facilitating detection of threats in a network as defined by claim 1.
